(19) United States
(12) Patent Application Publication
(10) Pub. No.: US 2024/0400044 A1
(43) Pub. Date: Dec. 5, 2024

(54) IN-VEHICLE DEVICE, IN-VEHICLE SYSTEM, CONTROL METHOD, AND COMPUTER PROGRAM

(71) Applicants: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(72) Inventor: Akihiro OGAWA, Osaka-shi, Osaka (JP)

(73) Assignees: Sumitomo Electric Industries, Ltd., Osaka-shi, Osaka (JP); AutoNetworks Technologies, Ltd., Yokkaichi-shi, Mie (JP); Sumitomo Wiring Systems, Ltd., Yokkaichi-shi, Mie (JP)

(21) Appl. No.: 18/698,367

(22) PCT Filed: Aug. 2, 2022
(86) PCT No.: PCT/JP2022/029575

§ 371 Date: Apr. 4, 2024

(30) Foreign Application Priority Data
Oct. 6, 2021 (JP) 2021-164872

(51) Int. Cl. B60W 30/09

(52) U.S. Cl. CPC B60W 30/09; B60W 2554/4041

(57) ABSTRACT

An in-vehicle device installed in a vehicle having an automated driving function, includes: an allowable delay estimation unit that estimates, as an allowable delay, a time until the vehicle reaches a dynamic object; a transfer delay estimation unit that estimates, as a transfer delay, a time from when the in-vehicle device receives data from outside of the vehicle to when the in-vehicle device transfers the data to an execution unit for executing the automated driving function, based on load states of information processing and information transfer in the vehicle; a determination unit that selects a specific analysis process from among a plurality of analysis processes for analyzing the data received from the outside, based on a difference between the allowable delay and the transfer delay; and a driving support information generation unit configured to generate driving support information by executing the specific analysis process selected by the determination unit.

### TECHNICAL FIELD

The present disclosure relates to an in-vehicle device, an in-vehicle system, a control method, and a computer program. This application claims priority on Japanese Patent Application No. 2021-164872 filed on Oct. 6, 2021, the entire content of which is incorporated herein by reference.

### BACKGROUND ART

Various systems for supporting drivers of automobiles, motorcycles, and the like (hereinafter referred to as vehicles) have been proposed. For example, it is proposed to collect sensor information from roadside devices that are set on roads and their peripheries and are provided with various sensors (e.g., camera, radar, etc.), and analyze the sensor information to provide traffic-related information (e.g., accident, traffic jam, etc.) as dynamic driving support information to a vehicle. In addition, with increase in speed of a mobile communication line, it is also proposed to collect information from sensor devices installed in vehicles, as well as the sensors of the roadside devices, and effectively use the information for driving support through communication via a server computer, or direct vehicle-to-vehicle communication.

Introduction of plug-in hybrid electric vehicles (PHEV), electric vehicles (EV), and the like is progressing, and recent vehicles, including these electric vehicles, are provided with various types of electronic equipment, and electric control units (ECUs) for controlling the equipment. For example, an automated driving ECU is installed in a vehicle capable of automated driving. The automated driving ECU communicates with the outside as appropriate, and acquires necessary information (e.g., road traffic information, or dynamic driving support information). Other examples of ECUs include an engine control ECU, a stop-start control ECU, a transmission control ECU, an airbag control ECU, a power steering control ECU, and a hybrid control ECU.

PATENT LITERATURE 1 discloses a technology of controlling transmission of hierarchized information to user terminals, based on a determination result according to the positional relationship (e.g., distance) and the movement state (e.g., acceleration) between two user terminals, although the hierarchized information does not relate to driving support.

### CITATION LIST

### Patent Literature

PATENT LITERATURE 1: International Publication No. WO2014/038323

### SUMMARY OF THE INVENTION

An in-vehicle device according to an aspect of the present disclosure is an in-vehicle device installed in a vehicle having an automated driving function, and includes: an allowable delay estimation unit configured to estimate, as an allowable delay, a time until the vehicle reaches a dynamic object; a transfer delay estimation unit configured to estimate, as a transfer delay, a time from when the in-vehicle device receives data from outside of the vehicle to when the in-vehicle device transfers the data to an execution unit for executing the automated driving function, based on load states of information processing and information transfer in the vehicle; a determination unit configured to select a specific analysis process from among a plurality of analysis processes for analyzing the data received from the outside, based on a difference between the allowable delay and the transfer delay; and a driving support information generation unit configured to generate driving support information by executing the specific analysis process selected by the determination unit. The data received from the outside includes information regarding the dynamic object. The driving support information is transferred to the execution unit for executing the automated driving function.

An in-vehicle system according to another aspect of the present disclosure is an in-vehicle system installed in a vehicle having an automated driving function, and includes: an execution unit configured to execute the automated driving function, a communication unit configured to acquire data including information regarding a dynamic object; and the above-described in-vehicle device.

A control method according to still another aspect of the present disclosure is a control method for supporting an automated driving function of a vehicle, and includes: an allowable delay estimation step of estimating, as an allowable delay, a time until the vehicle reaches a dynamic object; a transfer delay estimation step of estimating, as a transfer delay, a time from when an in-vehicle device installed in the vehicle receives data from outside of the vehicle to when the in-vehicle device transfers the data to an execution unit for executing the automated driving function, based on load states of information processing and information transfer in the vehicle; a determination step of selecting a specific analysis process from among a plurality of analysis processes for analyzing the data received from the outside, based on a difference between the allowable delay and the transfer delay; and a driving support information generation step of generating driving support information by executing the specific analysis process selected in the determination step. The data received from the outside includes information regarding the dynamic object. The driving support information is transferred to the execution unit for executing the automated driving function.

A computer program according to still another aspect of the present disclosure is a computer program that causes a computer installed in a vehicle to execute: an allowable delay estimation function of estimating, as an allowable delay, a time until the vehicle reaches a dynamic object; a transfer delay estimation function of estimating, as a transfer delay, a time from when the computer receives data from outside of the vehicle to when the computer transfers the data to an execution unit for executing the automated driving function, based on load states of information processing and information transfer in the vehicle; a determination function of selecting a specific analysis process from among a plurality of analysis processes for analyzing the data received from the outside, based on a difference between the allowable delay and the transfer delay; and a driving support information generation function of generating driving support information by executing the specific analysis process selected by the determination function. The data received from the outside includes information regarding the dynamic object. The driving support information is transferred to the execution unit for executing the automated driving function.

### BRIEF DESCRIPTION OF DRAWINGS

FIG. 1 is a schematic diagram showing a use form of an in-vehicle system according to an embodiment of the present disclosure.

FIG. 2 is a block diagram showing a hardware configuration of the in-vehicle system shown in FIG. 1.

FIG. 3 is a block diagram showing a hardware configuration of an in-vehicle gateway shown in FIG. 2.

FIG. 4 is a block diagram showing a functional configuration of the in-vehicle gateway shown in FIG. 2.

FIG. 5 schematically shows a processing state by the functions shown in FIG. 4.

FIG. 6 is a flowchart showing processing related to generation and transfer of hierarchical information, executed by the in-vehicle gateway.

FIG. 7 is a flowchart showing processing in which additional processes are executed in order.

FIG. 8 schematically shows a situation in which data to be provided to an automated driving ECU changes according to a distance from an own vehicle to a dynamic object, in an in-vehicle system of one vehicle.

FIG. 9 is a plan view showing vehicles approaching an intersection, and a traffic state at an intersection with the lapse of time.

FIG. 10 shows an example of information presented in a vehicle.

FIG. 11 shows an example of information presented in the vehicle subsequently to FIG. 10.

FIG. 12 shows an example of information presented in the vehicle subsequently to FIG. 11.

FIG. 13 shows an example of information presented in the vehicle subsequently to FIG. 12.

FIG. 14 is a block diagram showing a configuration of an in-vehicle system according to a modification.

FIG. 15 is a block diagram showing a hardware configuration of an extension device shown in FIG. 14.

### DETAILED DESCRIPTION

### Problems to be Solved by the Present Disclosure

The quality of driving support information, such as the level of detail and accuracy, can be improved by acquiring sensor data and analyzing the same to generate and integrate dynamic information regarding detected objects (i.e., dynamic objects such as a person, a vehicle, etc.). Meanwhile, transmission/reception and analysis of the sensor data, etc., take time, and such time causes a delay time. There is a trade-off relationship between the quality of the driving support information and the delay time, and a time range in which the driving support information can be applied to control of vehicle travel varies depending on traffic conditions. For example, when driving support information is provided to a vehicle from a server computer or the like, if the distance between the vehicle and a dynamic object is relatively large, detailed information can be generated by taking a long time for an analysis process, and provided to the vehicle. However, when the distance between the vehicle and the dynamic object is relatively small, even if detailed information is generated by taking a long time for the analysis process and provided to the vehicle, the vehicle does not have enough time to effectively use the detailed information, and the detailed information is wasted. Moreover, depending on the state of the vehicle, it may take some time from when the driving support information is received to when it is actually used (e.g., presence of a delay time in the vehicle). Therefore, when the dynamic information is provided to the vehicle as the driving support information, it is required to provide appropriate driving support information, while also considering a delay time in the vehicle, so that the information can be effectively used.

However, PATENT LITERATURE 1 cannot meet this requirement. In PATENT LITERATURE 1, since output of the hierarchical information cannot be controlled according to the delay, it is difficult to apply the hierarchical information to highly real-time services such as vehicle driving support and automated driving.

Therefore, it is an object of the present disclosure to provide an in-vehicle device, an in-vehicle system, a control method, and a computer program capable of generating appropriately hierarchized driving support information in the corresponding vehicle, according to an estimated time until the vehicle reaches a dynamic object, and capable of using the driving support information for travel control of the vehicle.

### Effects of the Present Disclosure

According to the present disclosure, it is possible to provide an in-vehicle device, an in-vehicle system, a control method, and a computer program capable of generating appropriately hierarchized driving support information in the corresponding vehicle, according to an estimated time until the vehicle reaches a dynamic object, and capable of using the driving support information for travel control of the vehicle.

### Description of Embodiment of the Present Disclosure

Contents of the embodiment of the present disclosure will be listed and described. At least some parts of the embodiment described below may be combined together as desired.

(1) An in-vehicle device according to a first aspect of the present disclosure is an in-vehicle device installed in a vehicle having an automated driving function, and includes: an allowable delay estimation unit configured to estimate, as an allowable delay, a time until the vehicle reaches a dynamic object; a transfer delay estimation unit configured to estimate, as a transfer delay, a time from when the in-vehicle device receives data from outside of the vehicle to when the in-vehicle device transfers the data to an execution unit for executing the automated driving function, based on load states of information processing and information transfer in the vehicle; a determination unit configured to select a specific analysis process from among a plurality of analysis processes for analyzing the data received from the outside, based on a difference between the allowable delay and the transfer delay; and a driving support information generation unit configured to generate driving support information by executing the specific analysis process selected by the determination unit. The data received from the outside includes information regarding the dynamic object. The driving support information is transferred to the execution unit for executing the automated driving function. Thus, driving support information hierarchized in appropriate hierarchical layers can be generated in the own vehicle according to the time until the own vehicle reaches the dynamic object, i.e., the distance between the own vehicle and the dynamic object, and the driving support information can be used for travel control of the own vehicle. The in-vehicle device is not limited to one that is installed as standard equipment in a vehicle having an automated driving function, and may include an in-vehicle device that can be installed later as an extension device. The automated driving preferably includes all the levels not lower than level 1 (i.e., driver assistance) described later.

(2) In the above (1), the data received from the outside may further include sensor data, the information regarding the dynamic object may include position information and simple attribute information of the dynamic object, and the driving support information generation unit may generate the driving support information that is hierarchized so as to include, as hierarchical layers, a result of the specific analysis process, and the position information and the simple attribute information. Thus, the position information and the simple attribute information of the dynamic object, which are provided from the outside of the vehicle, can be effectively used as the driving support information. In addition, by analyzing the sensor data, driving support information including detailed attributes, etc., of the dynamic object can be generated. By analyzing the position information and the simple attribute information of the dynamic object, driving support information including movement prediction, etc., of the dynamic object can be generated.

(3) In the above (2), the driving support information may include: a first layer including an analysis result of the specific analysis process performed on the sensor data being a processing target; and a second layer including an analysis result of the specific analysis process not performed on the sensor data. Thus, driving support information that includes the detailed attributes, etc., of the dynamic object and the movement prediction, etc., of the dynamic object, as different hierarchical layers, can be generated, whereby the driving support information can be efficiently used when being provided to an execution unit for executing automated driving (i.e., automated driving ECU).

(4) In the above (2) or (3), the specific analysis process not performed on the sensor data may have, as a processing target, at least one of the analysis result of the specific analysis process performed on the sensor data, and the information regarding the dynamic object. Thus, the accuracy of the specific analysis process not performed on the sensor data can be improved.

(5) In any one of the above (1) to (4), the determination unit may calculate the difference by subtracting the transfer delay from the allowable delay, determine whether or not the difference is larger than a predetermined value that is equal to or larger than 0, select the specific analysis process when the difference is larger than the predetermined value, and not select the specific analysis process when the difference is equal to or smaller than the predetermined value. Thus, an appropriate specific analysis process can be selected, and useless processes can be inhibited.

(6) In the above (5), when the difference is equal to or smaller than the predetermined value, the information regarding the dynamic object may be transferred to the execution unit together with information indicating that the transfer delay is equal to or larger than the allowable delay. Thus, the execution unit for executing automated driving can determine whether or not use of the information regarding the dynamic object is appropriate, and the information regarding the dynamic object can be used.

(7) In the above (5) or (6), the in-vehicle device may further include a storage unit having, stored therein, a processing time table in which, for each of the plurality of analysis processes, a processing time corresponding to an amount of data to be processed is recorded. When the difference is larger than the predetermined value, the determination unit may specify a processing time for the data with reference to the processing time table by using the amount of the data, and thereafter may determine whether or not the processing time is equal to or less than the difference, thereby selecting the specific analysis process. Thus, an appropriate specific analysis process can be selected, and the analysis result can be effectively used for travel control of the vehicle.

(8) In the above (7), the processing time table may further include an acquisition time required for newly acquiring sensor data being a processing target, regarding an analysis process having the sensor data as the processing target among the plurality of analysis processes. When the difference is larger than the predetermined value, the determination unit may determine whether or not a sum of the processing time and the acquisition time, which are specified with reference to the processing time table, is equal to or smaller than the difference, thereby selecting the specific analysis process. Thus, when the sensor data is newly acquired and analyzed, an appropriate specific analysis process can be selected, and the analysis result can be effectively used for travel control of the vehicle.

(9) An in-vehicle system according to a second aspect of the present disclosure is an in-vehicle system installed in a vehicle having an automated driving function, and includes: an execution unit configured to execute the automated driving function; a communication unit configured to acquire data including information regarding a dynamic object; and the in-vehicle device according to any one of the above (1) to (8). Thus, driving support information hierarchized in appropriate hierarchical layers can be generated in the own vehicle according to the time until the own vehicle reaches the dynamic object, i.e., the distance between the own vehicle and the dynamic object, and the driving support information can be used for travel control of the own vehicle.

(10) In the above (9), the communication unit may transmit the driving support information generated by the in-vehicle device to another vehicle together with information on a position and a traveling direction of the vehicle. Thus, travel control of the other vehicle can be performed by using the driving support information without necessity of executing an analysis process in the other vehicle.

(11) In the above (10), the determination unit of the in-vehicle device may estimate a communication time of the driving support information to be transmitted from the communication unit, and may select the specific analysis process from among the plurality of analysis processes, based on a difference between the allowable delay and a sum of the transfer delay and the communication time. Thus, an appropriate specific analysis process can be selected, and unnecessary analysis can be inhibited.

(12) A control method according to a third aspect of the present disclosure is a control method for supporting an automated driving function of a vehicle, and includes: an allowable delay estimation step of estimating, as an allowable delay, a time until the vehicle reaches a dynamic object; a transfer delay estimation step of estimating, as a transfer delay, a time from when an in-vehicle device installed in the vehicle receives data from outside of the vehicle to when the in-vehicle device transfers the data to an execution unit for executing the automated driving function, based on load states of information processing and information transfer in the vehicle; a determination step of selecting a specific analysis process from among a plurality of analysis processes for analyzing the data received from the outside, based on a difference between the allowable delay and the transfer delay; and a driving support information generation step of generating driving support information by executing the specific analysis process selected in the determination step. The data received from the outside includes information regarding the dynamic object. The driving support information is transferred to the execution unit for executing the automated driving function. Thus, driving support information hierarchized in appropriate hierarchical layers can be generated in the own vehicle according to the time until the own vehicle reaches the dynamic object, i.e., the distance between the own vehicle and the dynamic object, and the driving support information can be used for travel control of the own vehicle.

(13) A computer program according to a fourth aspect of the present disclosure is a computer program that causes a computer installed in a vehicle to execute: an allowable delay estimation function of estimating, as an allowable delay, a time until the vehicle reaches a dynamic object; a transfer delay estimation function of estimating, as a transfer delay, a time from when the computer receives data from outside of the vehicle to when the computer transfers the data to an execution unit for executing the automated driving function, based on load states of information processing and information transfer in the vehicle; a determination function of selecting a specific analysis process from among a plurality of analysis processes for analyzing the data received from the outside, based on a difference between the allowable delay and the transfer delay; and a driving support information generation function of generating driving support information by executing the specific analysis process selected by the determination function. The data received from the outside includes information regarding the dynamic object. The driving support information is transferred to the execution unit for executing the automated driving function. Thus, driving support information hierarchized in appropriate hierarchical layers can be generated in the own vehicle according to the time until the own vehicle reaches the dynamic object, i.e., the distance between the own vehicle and the dynamic object, and the driving support information can be used for travel control of the own vehicle.

### Details of Embodiment of the Present Disclosure

In the embodiment below, the same components are denoted by the same reference signs. The names and functions of such components are also the same. Therefore, detailed descriptions thereof are not repeated.

### [Overall Configuration]

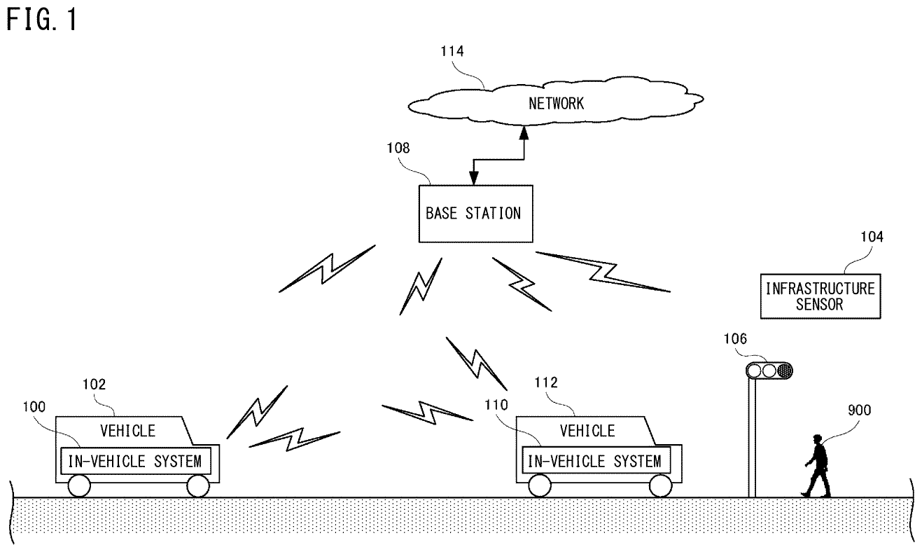

With reference to FIG. 1, an in-vehicle system 100 according to the embodiment of the present disclosure is installed in a vehicle 102. The in-vehicle system 100 communicates with an infrastructure sensor 104 that is fixedly installed on a road (including an intersection) and its periphery or the like (hereinafter also referred to as “roadside”), and receives sensor data, and dynamic information being an analysis result of the sensor data. The in-vehicle system 100 communicates with an in-vehicle system 110 installed in another vehicle 112, and receives sensor data of an installed sensor and dynamic information. The in-vehicle system 100 also communicates with a traffic signal 106, and acquires information regarding the state of the traffic signal (hereinafter referred to as “signal information”). These communications may be communications via a base station 108, or may be direct communications not via the base station 108.

The base station 108 provides a mobile communication service using, for example, a 4G (4th-generation mobile communication system) line, a 5G (5th-generation mobile communication system) line, or the like. The base station 108 is connected to a network 114. The infrastructure sensor 104 and the traffic signal 106 may also be connected to the network 114.

The in-vehicle system 100 and the in-vehicle system 110 installed in the vehicle 102 and the vehicle 112, respectively, each have a communication function based on the communication specification (e.g., 4G line, 5G line, or the like) that the base station 108 services. As described above, the in-vehicle system 100 and the in-vehicle system 110 also have a function of directly communicating with each other not via the base station 108 (i.e., V2V (Vehicle to Vehicle)). For example, Wi-Fi communication is used for the mutual communication not via the base station 108.

A pedestrian 900, the vehicle 102, and the vehicle 112 shown in FIG. 1 are objects to be detected by the infrastructure sensor 104. The pedestrian 900 is an object to be detected by the sensors installed in the vehicle 102 and the vehicle 112.

The infrastructure sensor 104 is a device that is installed on a roadside and has a function of acquiring information on the roadside. The infrastructure sensor 104 has a communication function with the base station 108. The infrastructure sensor 104 is, for example, an image sensor (e.g., digital monitoring camera), a radar (e.g., millimeter-wave radar), a laser sensor (e.g., LiDAR (Light Detection And Ranging)), or the like. The infrastructure sensor 104 may be installed in or connected to a roadside unit having an arithmetic function.

The sensor data acquired by the sensors installed in the vehicle 102 and the vehicle 112 are analyzed in the in-vehicle system 100 and the in-vehicle system 110, respectively, and the analysis results are stored as dynamic information. The dynamic information is used for an automated driving function of the corresponding vehicle. Automated driving is divided into levels from level 1 to level 5 based on who/what mainly performs the driving (i.e., a person or a system) and on a traveling area (i.e., limited or unlimited). Preferably, the automated driving in which the dynamic information can be used is not limited to level 4 and higher (full automation) in which not a person but a system mainly performs the driving, but also includes level 1 and level 2 (driver assistance or the like) in which a person mainly performs the driving, and level 3 (conditional automation). That is, the automated driving in which the dynamic information can be used may be any of the automated driving levels from level 1 to level 5, or may be one of the automated driving levels from level 1 to level 5. In addition, the sensor data and the dynamic information can be mutually communicated between the in-vehicle system 100 and the in-vehicle system 110, as described above. The in-vehicle system 100 and the in-vehicle system 110 also mutually communicate information about the vehicles in which the systems 100, 110 are installed (e.g., position information, speed information, traveling direction information, etc.). Hereinafter, the position information, the speed information, and the traveling direction information are also simply referred to as a position, a speed, and a traveling direction, respectively. The information about the vehicle can be used for specifying the position and the direction at which the sensor data transmitted from the vehicle is acquired.

The dynamic information is information regarding a dynamic object detected by the sensor (i.e., the infrastructure sensor or the in-vehicle sensor). The dynamic object is not limited to a moving object (e.g., a person, a vehicle, etc.), and includes an object that has a moving function but is stopped. The dynamic information may include information about the dynamic object itself (hereinafter referred to as “attribute”), and information regarding displacement of the dynamic object (e.g., position, movement speed, movement direction, time, etc.). The dynamic information is used for generating driving support information described later. Here, driving support information to be used for automated driving of the own vehicle only needs to be related to a predetermined area including a travel route of the own vehicle (i.e., a road on which the own vehicle will travel).

The attribute is divided into, for example, a simple attribute and a detailed attribute. The simple attribute is for roughly classifying the dynamic object, and includes “person”, “bicycle”, “motorcycle”, “automobile”, etc. The detailed attribute is for specifically classifying the dynamic object, and includes the state of the dynamic object. For example, when the simple attribute is “person”, the detailed attribute may include “child”, “adult”, “elderly person”, etc., and may further include “using a smartphone while walking” (i.e., browsing on a smartphone or the like while walking), “ignoring a traffic signal”, etc. For example, when the simple attribute is “automobile”, the detailed attribute may include, for example, “general automobile”, “large automobile”, etc., and may further include “bus”, “taxi”, “emergency vehicle” (e.g., ambulance and fire truck), “inattentive driving”, etc. The simple attribute and the detailed attribute are not limited to those described above, and may include any attribute.

Of pieces of information regarding the displacement of the dynamic object, time information indicates, for example, generation times of position information, movement speed information, movement direction information, etc. In addition, the dynamic information may include prediction information. For example, if the in-vehicle system 100 or the in-vehicle system 110 has a prediction function, the system can predict a movement path, a movement speed, and a movement direction in the future (e.g., within a predetermined time from the present time) by using the movement path, the movement speed, and the movement direction up to the present time which are obtained from change in the position of the dynamic object. These pieces of information may be included in the dynamic information.

FIG. 1 shows one base station 108, one infrastructure sensor 104, one traffic signal 106, and two vehicles 102 and 112 having in-vehicle systems installed therein. However, this configuration is merely an example. Usually, a plurality of base stations are installed, and three or more vehicles have in-vehicle systems installed therein. A vehicle having no in-vehicle system installed therein may exist. The vehicle in which no in-vehicle system is installed is detected as a dynamic object.

### [Hardware Configuration of In-Vehicle System]

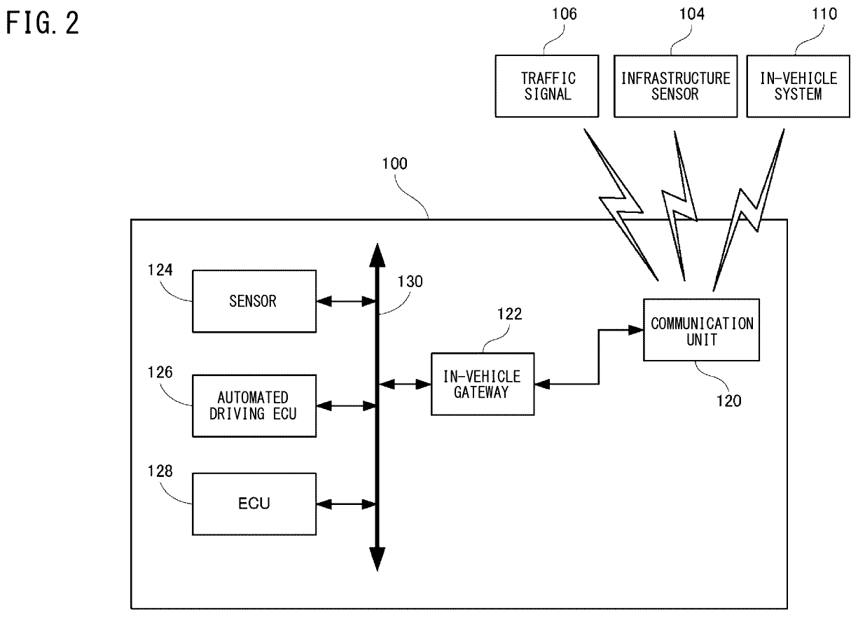

With reference to FIG. 2, an example of a hardware configuration of the in-vehicle system 100 installed in the vehicle 102 will be described. The in-vehicle system 110 installed in the vehicle 112 has the same configuration as the in-vehicle system 100. The in-vehicle system 100 includes a communication unit 120, an in-vehicle gateway 122, a sensor 124, an automated driving ECU 126, an ECU 128, and a bus 130. The in-vehicle system 100 includes a plurality of ECUs in addition to the automated driving ECU 126. In FIG. 2, the ECU 128 is shown as a representative of these ECUs.

The communication unit 120 performs wireless communication with an external device outside the vehicle 102 (e.g., communication with the in-vehicle system 110 via the base station 108). The communication unit 120 includes an IC for performing modulation and multiplexing adopted in the wireless communication, an antenna for transmitting and receiving a radio wave of a predetermined frequency, an RF circuit, and the like. The communication unit 120 also has a communication function with GNSS (Global Navigation Satellite System) such as GPS (Global Positioning System). The communication unit 120 may have a communication function with Wi-Fi or the like.

The in-vehicle gateway 122 being an in-vehicle device serves to connect the communication function (i.e., communication specification) with the outside and the communication function (i.e., communication specification) inside the vehicle, i.e., serves to perform communication protocol conversion, etc. The automated driving ECU 126 can communicate with the external device via the in-vehicle gateway 122 and the communication unit 120. The in-vehicle gateway 122 acquires, out of pieces of information received from the outside via the communication unit 120, the dynamic information and the sensor data used for generation of the dynamic information, and generates and updates driving support information as described later. The driving support information is transmitted to the automated driving ECU 126. The bus 130 serves as a communication function inside the vehicle, and mutual communication (data exchange) between the in-vehicle gateway 122, the sensor 124, the automated driving ECU 126, and the ECU 128 is performed via the bus 130. For example, a CAN (Controller Area Network) is used as the bus 130.

The sensor 124 is installed in the vehicle 102, and includes: a sensor for acquiring information from the outside of the vehicle 102 (e.g., a video image capturing device (e.g., a digital camera (e.g., a CCD camera or a CMOS camera)), a laser sensor (e.g., LiDAR), etc.); and a sensor for acquiring information about the vehicle itself (e.g., an acceleration sensor, a load sensor, etc.). The sensor 124 acquires information within a detection range (e.g., an image capturing range if it is a camera), and outputs the information as sensor data. If the camera is a digital camera, digital image data is outputted. A detection signal (i.e., an analog or digital signal) of the sensor 124 is outputted as digital data to the bus 130 via an I/F unit (not shown), and is transmitted to the in-vehicle gateway 122, the automated driving ECU 126, etc.

The automated driving ECU 126 controls traveling of the vehicle 102. For example, the automated driving ECU 126 acquires the sensor data, analyzes the sensor data to grasp the situation around the vehicle, and controls the mechanisms relating to automated driving (e.g., mechanisms such as an engine, a transmission, a steering wheel, and a brake). The automated driving ECU 126 uses, for automated driving, the driving support information acquired from the in-vehicle gateway 122.

### [Hardware Configuration of In-Vehicle Gateway]

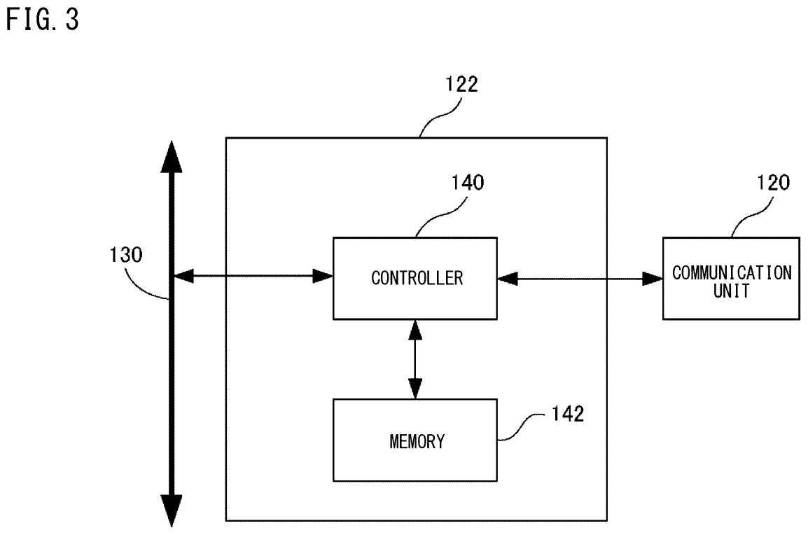

With reference to FIG. 3, the in-vehicle gateway 122 includes a controller 140 and a memory 142. The controller 140 is configured to include a CPU (Central Processing Unit), and controls the memory 142. The memory 142 is, for example, a rewritable nonvolatile semiconductor memory, and has, stored therein, a computer program (hereinafter referred to simply as “program”) that the controller 140 executes. The memory 142 provides a work area for the program that the controller 140 executes. The controller 140 acquires data to be processed, directly from the communication unit 120, and via the bus 130 from the components other than the communication unit 120. The controller 140 stores the processing result in the memory 142, and outputs the same to the bus 130.

### [Functional Configuration]

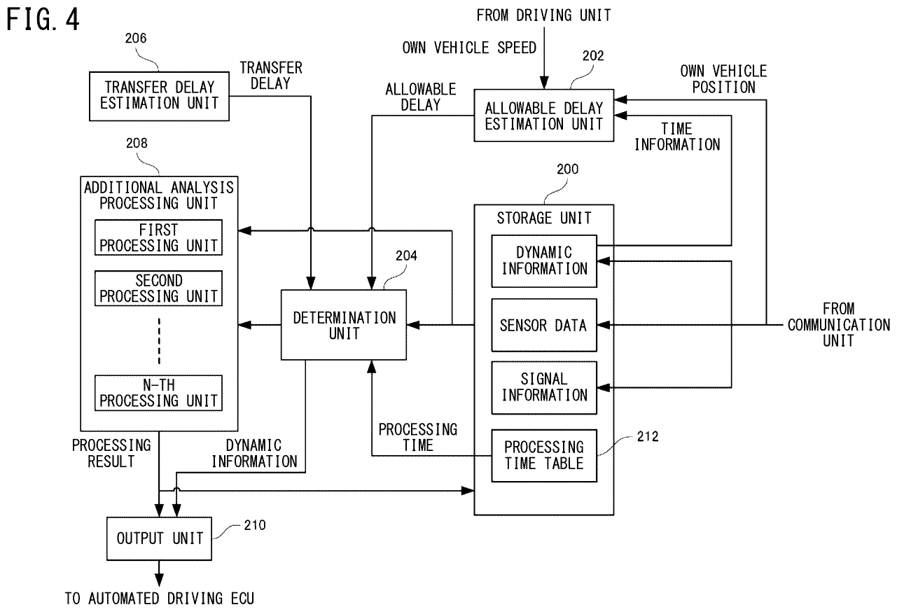

With reference to FIG. 4, functions of the in-vehicle gateway 122 will be described. In the following description, the vehicle 102 shown in FIG. 1 is referred to as “own vehicle”, and the vehicle 112 traveling ahead of the vehicle 102 is referred to as “another vehicle”. The in-vehicle system 100 acquires the position and the simple attribute of a dynamic object as dynamic information from an external device (e.g., the infrastructure sensor 104, the in-vehicle system 110, etc.). The position and the simple attribute may be transmitted together with the sensor data that was an analysis target when they were generated. That is, the vehicle 102 receives only the dynamic information (i.e., position and simple attribute), receives only the sensor data, or receives the dynamic information and the corresponding sensor data.

The in-vehicle gateway 122 includes a storage unit 200, an allowable delay estimation unit 202, a determination unit 204, a transfer delay estimation unit 206, an additional analysis processing unit 208, and an output unit 210. The storage unit 200 stores therein the data received by the communication unit 120, and the sensor data of the sensor 124 inputted via the bus 130. The data inputted from the communication unit 120 includes the dynamic information (i.e., position and simple attribute), the sensor data, the signal information, the position information of the own vehicle, etc. The storage unit 200 is realized by the memory 142 shown in FIG. 3. The other functions described later are realized by the controller 140.

As described later, the additional analysis processing unit 208 and the output unit 210 constitute a driving support information generation unit.

The allowable delay estimation unit 202 estimates an allowable delay, based on the distance between the own vehicle and the dynamic object included in the dynamic information acquired from the communication unit 120. Specifically, the allowable delay estimation unit 202 calculates, from the positions of the dynamic object and the own vehicle at the same time (including a certain error), a distance L between the dynamic object and the own vehicle, and divides the distance L by a speed V of the own vehicle to obtain an allowable delay Tp (=L/V). The allowable delay Tp is an estimated time until the own vehicle reaches the dynamic object. As the time of the dynamic object, the time at which the dynamic information (i.e., position and simple attribute) was received (e.g., the time at which packet data was received and configured as the dynamic information) may be used. If the position (e.g., GPS data) of the own vehicle acquired from the communication unit 120 is associated with the reception time thereof and stored, the position of the own vehicle at the same time as when the position of the dynamic object was obtained can be specified. The speed of the own vehicle is acquired from a driving unit that causes the own vehicle to travel (i.e., an object to be controlled by the automated driving ECU 126). As the speed V of the own vehicle, for example, the current speed, an average speed within a most-recent predetermined time period, or the like, may be used. The distance L may be a linear distance, but preferably is a distance along a road on which the own vehicle is planned to travel. The allowable delay estimation unit 202 outputs the estimated allowable delay Tp to the determination unit 204.

The transfer delay estimation unit 206 observes the load state of information processing and information transmission in the own vehicle, and estimates a delay time (hereinafter referred to as “transfer delay”) required until data (i.e., driving support information described later) is transferred to the automated driving ECU 126. The transfer delay is, for example, a time period from when the in-vehicle gateway 122 starts transfer of the data received by the communication unit 120 to the automated driving ECU 126, to when the automated driving ECU 126 completes reception of the data. The transfer delay Tt depends on, for example, the empty state of the bus 130 (i.e., the state in which data transfer via the bus 130 is not performed, and this state corresponds to the load state of information transmission), or the load state of information processing of the controller 140 itself. For example, when the bus 130 is a CAN, a multi-master mode and an event driven mode are adopted. That is, a node (e.g., an ECU or the like) that has firstly started transmission when the bus 130 is empty acquires the transmission right, and a node that is higher in priority acquires the transmission right in order to avoid collision during data transmission via the bus 130. Therefore, the transfer delay estimation unit 206 (i.e., controller 140) observes the load state of the bus 130 (i.e., whether or not the bus 130 is empty), in addition to the load state of the controller 140 itself, and estimates the load state of information processing and information transmission. For example, when the transmission right has been acquired by a node, the load state of information transmission can be estimated by observing the priority of the node. The transfer delay estimation unit 206 outputs the estimated transfer delay Tt to the determination unit 204.

The determination unit 204 determines whether or not further analysis (hereinafter referred to as “additional analysis”) of the dynamic information (i.e., position and simple attribute) and the sensor data stored in the storage unit 200 can be performed, by using the allowable delay Tp inputted from the allowable delay estimation unit 202 and the transfer delay Tt inputted from the transfer delay estimation unit 206. Specifically, the determination unit 204 determines whether or not the allowable delay Tp is greater than the transfer delay Tt (i.e., Tp>Tt). When the allowable delay Tp is equal to or smaller than the transfer delay Tt (i.e., Tp≤Tt), there is no time for such additional analysis. However, when the allowable delay Tp is greater than the transfer delay Tt (i.e., Tp>Tt), there is time to spare for additional analysis. When the allowable delay Tp is greater than the transfer delay Tt, the determination unit 204 selects a process to be executed from among a plurality of predetermined additional analysis processes, based on a difference between Tp and Tt (i.e., Tp−Tt). The determination unit 204 outputs information for specifying the selected additional analysis process (hereinafter referred to as “analysis process specifying information”) to the additional analysis processing unit 208.

When the allowable delay Tp is greater than the transfer delay Tt, the determination unit 204 selects an additional analysis process to be executed, by determining whether or not the additional analysis process can be completed within Tp−Tt. The additional analysis processes include an analysis process to be performed on the sensor data, and an analysis process to be performed on data other than the sensor data (e.g., dynamic information, and hereinafter referred to as “non-sensor data”). Even in the same analysis process, the greater the amount of data to be processed, the longer the processing time is required. Therefore, for example, a processing time table 212 in which, for each additional analysis process, the amount of data to be processed is associated with the processing time, is stored in the storage unit 200 in advance. Thus, an appropriate additional analysis process can be selected, and the analysis result can be effectively used for travel control of the vehicle, as described later. In addition, it is possible to generate driving support information that includes a hierarchical layer (first layer) including the detailed attribute, etc., of the dynamic object, and a hierarchical layer (second layer) including the movement prediction, etc., of the dynamic object, as different layers. Such driving support information can be provided to the automated driving ECU and efficiently used.

The determination unit 204 reads out, from the processing time table 212, a processing time τi corresponding to a set of an additional analysis process i and the amount of data, and determines whether τi<Tp−Tt is satisfied. If τi<Tp−Tt is satisfied, since the process i can be completed within Tp−Tt, the additional analysis process i is selected. The additional analysis processes may be subjected to determination as to whether τi<Tp−Tt is satisfied, in any order. For example, it does not matter which of the process for the sensor data and the process for the non-sensor data is preferentially subjected to the determination. In addition, it does not matter which of the process having the shorter processing time and the process having the longer processing time is preferentially subjected to the determination. When one additional analysis process j has been selected, an additional analysis process i different from the additional analysis process j may be subjected to determination as to whether τi<Tp−Tt−τj is satisfied. Each time a new additional analysis process has been selected, similar determination may be performed with the value of τj being replaced with Στj. Note that Σ means an operator that calculates the sum of the processing times τj of the already selected additional analysis processes.

The processing time also changes depending on the calculation resource. Therefore, the processing time table 212 may be a table in which, for each additional analysis process, a set of the amount of data to be processed and the calculation resource is associated with the processing time. In this case, the processing time τi corresponding to the set of the additional analysis process i, the amount of data, and the calculation resource may be read out from the processing time table 212, and determination as to whether τi<Tp−Tt is satisfied may be performed in the same manner as described above.

The additional analysis processing unit 208 includes a plurality of functions (i.e., additional analysis processes) for analyzing the dynamic information and the sensor data. The plurality of analysis functions are realized by first to Nth processing units. The analysis processes to be executed by the first to Nth processing units are hierarchized according to the types thereof, and the analysis results thereof are also hierarchized. For example, the first to Nth processing units are classified (e.g., hierarchized) into a process of analyzing the sensor data, and a process of analyzing the non-sensor data.

For example, the first processing unit and the second processing unit analyze the sensor data. For example, the first processing unit and the second processing unit read out, from the storage unit 200, the original sensor data from which the dynamic object included in the dynamic information (i.e., position and simple attribute) has been detected, and analyze the sensor data to generate detailed information related to the dynamic object. For example, when the simple attribute of the dynamic object is a person, the first processing unit detects (i.e., specifies) which of a child, an adult, an elderly person, etc., the person is, and the second processing unit detects which of “using a smartphone while walking”, “ignoring a traffic signal”, etc., the attribute of the person is. For example, when the simple attribute of the dynamic object is an automobile, the first processing unit detects which of a general automobile, a large automobile, etc., the automobile is, and the second processing unit detects which of a bus, a taxi, an emergency vehicle, inattentive driving, etc., the automobile is. When reading out signal information from the storage unit 200, the second processing unit may detect a person or an automobile ignoring a traffic signal.

For example, the processing units other than the first processing unit and the second processing unit analyze the non-sensor data. For example, the third to fifth processing units (not shown) read out the dynamic information (i.e., position and simple attribute) and the signal information from the storage unit 200, and estimate the future position of the dynamic object (e.g., a person, an automobile, etc.) included therein. This analysis result is referred to as “movement prediction”. For example, the third processing unit analyzes change over time in the position of the same dynamic object stored in the storage unit 200, and predicts a movement area of the dynamic object after t seconds. For example, the fourth processing unit detects a current behavior (e.g., ignoring a traffic signal, etc.) of the dynamic object by using the signal information. For example, the fifth processing unit predicts a behavior of the dynamic object after t seconds (e.g., possibility of collision) by using the signal information. The analysis results of the fourth processing unit and the fifth processing unit are referred to as “traffic state prediction”. The traffic state prediction may include the result of prediction of the traffic state after t seconds which is predicted from the current traffic state (e.g., traffic jam, accident, etc.).

The additional analysis processing unit 208 executes the additional analysis process that is specified by the analysis process specifying information inputted from the determination unit 204 as described above. That is, the additional analysis processing unit 208 operates a processing unit specified by the analysis process specifying information from among the first to Nth processing units. The additional analysis processing unit 208 outputs the processing result obtained by the operated processing unit to the output unit 210.

The output unit 210 reads out the dynamic information (i.e., position and simple attribute) from the storage unit 200, generates driving support information hierarchized together with the analysis result inputted from the additional analysis processing unit 208, and outputs the same to the automated driving ECU 126. That is, the additional analysis processing unit 208 and the output unit 210 constitute a driving support information generation unit. Thus, hierarchized driving support information according to the estimated time (i.e., allowable delay) until the own vehicle reaches the dynamic object is generated and transferred to the automated driving ECU 126. Therefore, the automated driving ECU 126 can appropriately control traveling of the own vehicle by using the driving support information.

As described above, the data received from the outside includes the dynamic information and the sensor data, the information regarding the dynamic object includes the position and the simple attribute of the dynamic object, and the driving support information generation unit generates the hierarchized driving support information that includes, as the hierarchical layers, the result of the additional analysis process, and the position and the simple attribute. Thus, the position and the simple attribute of the dynamic object provided from the outside of the vehicle can be effectively used as the driving support information. In addition, by analyzing the sensor data, the driving support information including the detailed attribute, etc., of the dynamic object can be generated. By analyzing the position and the simple attribute of the dynamic object, the driving support information including the movement prediction, etc., of the dynamic object can be generated.

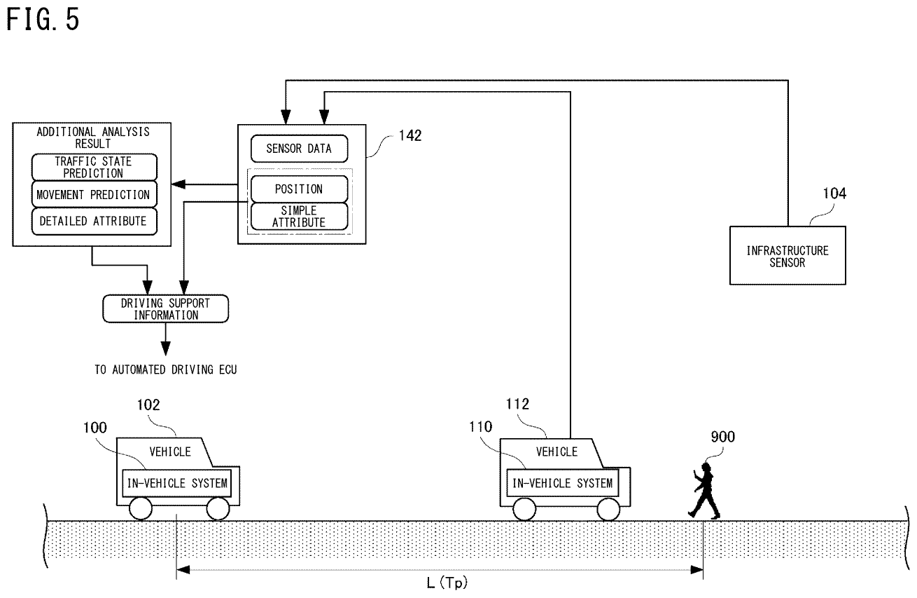

With reference to FIG. 5, the in-vehicle system 100 installed in the vehicle 102 acquires the dynamic information (i.e., position and simple attribute) and the sensor data of the dynamic object (i.e., pedestrian 900) from the infrastructure sensor 104 and the vehicle 112 (specifically, the in-vehicle system 110). The dynamic information is generated by analyzing the sensor data (e.g., captured image data), and the sensor data includes the dynamic object. The dynamic information and the sensor data are stored in the memory 142 in the in-vehicle gateway 122 in the in-vehicle system 100. Although not shown in FIG. 5, the in-vehicle system 100 also receives signal information from a traffic signal. As described above, the allowable delay estimation unit 202 calculates the allowable delay Tp, based on the distance L from the own vehicle (i.e., vehicle 102) to the dynamic object (i.e., pedestrian 900) and on the speed V of the own vehicle, and the transfer delay estimation unit 206 calculates the transfer delay Tt while considering the load state of the own vehicle. Based on the difference between the allowable delay Tp and the transfer delay Tt, the determination unit 204 selects an executable additional analysis process, and the additional analysis processing unit 208 executes the selected additional analysis process on the data read out from the storage unit 200 (i.e., memory 142). Thus, for example, the detailed attribute is generated as a result of the analysis process performed on the sensor data. In addition, for example, the movement prediction and the traffic state prediction are generated as a result of the analysis process performed on the non-sensor data (e.g., the position information, the simple attribute, and the signal information).

The processing result (e.g., the detailed attribute, the movement prediction, and the traffic state prediction) and the position and the simple attribute (surrounded by an alternate long and short dash line) read from the storage unit 200 (i.e., memory 142) are hierarchized to generate the driving support information, and the driving support information is transferred to the automated driving ECU 126. The driving support information transferred to the automated driving ECU 126 is the hierarchized information generated considering the delay time (e.g., the allowable delay, the transfer delay, and the analysis process time) as described above. Therefore, the automated driving ECU 126 can use the driving support information effectively for controlling traveling of the own vehicle.

### [Operation of In-Vehicle Gateway]

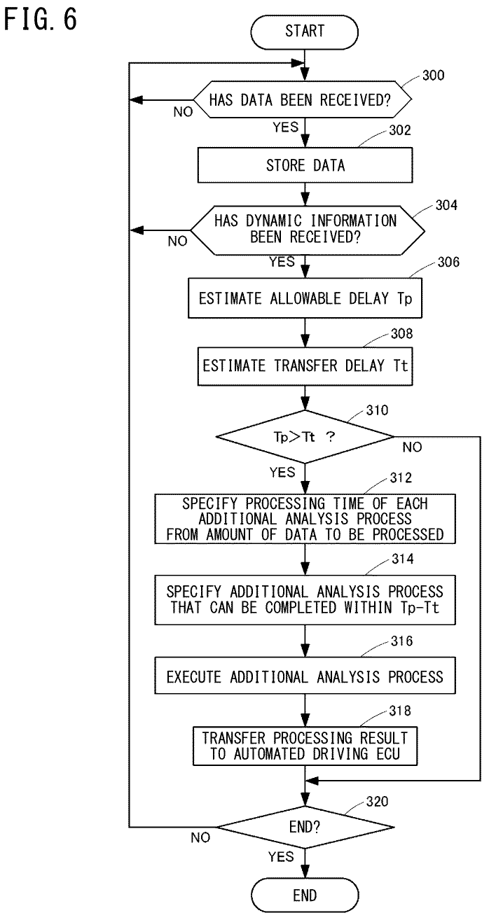

With reference to FIG. 6, the operation of the in-vehicle gateway 122 will be described while referring to the functions shown in FIG. 4. The process shown in FIG. 6 is realized when the controller 140 shown in FIG. 3 reads out a predetermined program from the memory 142 and executes the program.

With reference to FIG. 6, in step 300, the controller 140 determines whether or not data has been received by the communication unit 120. When it is determined that data has been received, the control proceeds to step 302. Otherwise, step 300 is repeated.

In step 302, the controller 140 stores the received data in the memory 142. The received data includes the sensor data transmitted from the infrastructure sensor 104 and the other vehicle 112, the dynamic information, and the signal information transmitted from the traffic signal 106.

In step 304, the controller 140 determines whether or not the dynamic information has been received. When it is determined that the dynamic information has been received, the control proceeds to step 306. Otherwise, the control proceeds to step 320.

In step 306, the controller 140 estimates the allowable delay Tp. Specifically, the controller 140 calculates an estimated time (i.e., L/V) until the own vehicle reaches the dynamic object, based on the distance L from the own vehicle to the dynamic object and on the speed V of the own vehicle, and sets the estimated time as the allowable delay Tp. This corresponds to the function of the allowable delay estimation unit 202 described above (see FIG. 4). Thereafter, the control proceeds to step 308.

In step 308, the controller 140 estimates the transfer delay Tt. Specifically, the controller 140 observes the load state inside the own vehicle, calculates a time required until the driving support information is transferred to the automated driving ECU 126, and sets this time as the transfer delay Tt. This corresponds to the function of the transfer delay estimation unit 206 described above (see FIG. 4). Thereafter, the control proceeds to step 310.

In step 310, the controller 140 determines whether or not the allowable delay Tp estimated in step 306 is greater than the transfer delay Tt estimated in step 308 (i.e., Tp>Tt). This corresponds to the function of the determination unit 204 described above (see FIG. 4). When it is determined that Tp>Tt, the control proceeds to step 312. Otherwise (i.e., Tp≤Tt), the control proceeds to step 320.

In step 312, with reference to the processing time table 212 (see FIG. 4), the controller 140 acquires, for each additional analysis process, the processing time τi corresponding to the amount of data to be processed. This corresponds to the function of the determination unit 204 described above (see FIG. 4).

In step 314, the controller 140 specifies one additional analysis process or a plurality of additional analysis processes which can be completed within a time represented by a value obtained by subtracting the transfer delay Tt from the allowable delay Tp (i.e., Tp−Tt). Specifically, the controller 140 determines whether or not the processing time of one additional analysis process or the sum of the processing times of a plurality of additional analysis processes is equal to or less than Tp−Tt. This corresponds to the function of the determination unit 204 described above (see FIG. 4).

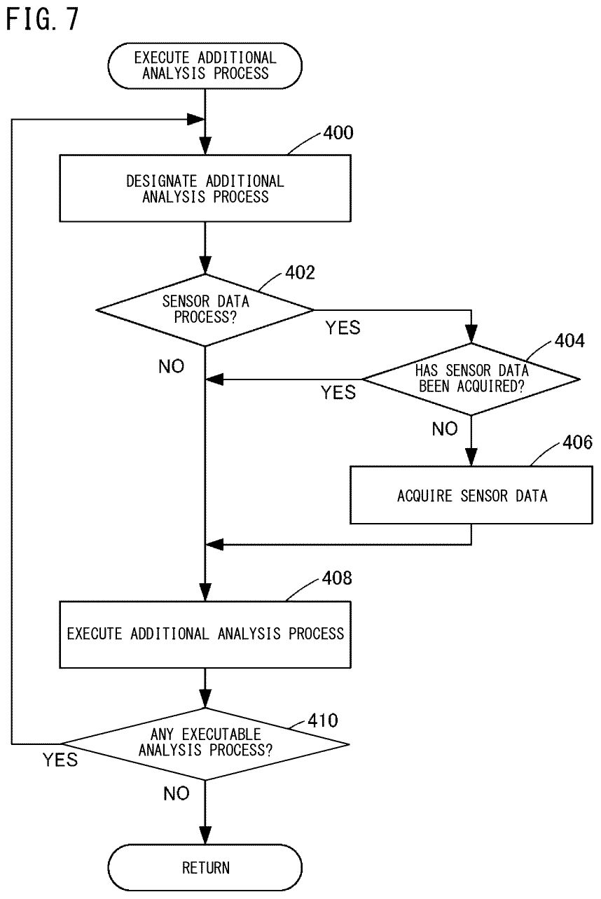

In step 316, the controller 140 executes the additional analysis process selected in step 314. This corresponds to the function of the additional analysis processing unit 208 described above (see FIG. 4). If a plurality of additional analysis processes are selected in step 314, the controller 140 may execute the additional analysis processes in a multitasking manner. The analysis result is stored in the memory 142 as appropriate. If the processes cannot be executed in the multitasking manner, the processes may be executed according to a flowchart shown in FIG. 7 described later.

In step 318, the controller 140 transfers the analysis result obtained in step 316 to the automated driving ECU 126 as the driving support information. Specifically, the controller 140 reads out the dynamic information (i.e., position and simple attribute) stored in the memory 142, generates driving support information hierarchized together with the processing result obtained in step 316, and transfers the hierarchized driving support information to the automated driving ECU 126. This corresponds to the function of the output unit 210 described above (see FIG. 4). Thus, the automated driving ECU 126 uses the transferred analysis result for travel control of the own vehicle.

In step 320, the controller 140 determines whether or not an end instruction has been received. When it is determined that an end instruction has been received, this program is ended. Otherwise, the control returns to step 300 to repeat the aforementioned processes. The end instruction is made by, for example, turning off the power supply installed in the vehicle 102.

Thus, the in-vehicle gateway 122, when receiving the dynamic information (i.e., position and simple attribute), executes the additional analysis process selected based on the allowable delay Tp, and provides the analysis result to the automated driving ECU 126. The additional analysis process to be executed varies depending on the distance from the own vehicle to the dynamic object. That is, if the distance from the own vehicle to the dynamic object is relatively large, the automated driving ECU 126 can acquire the detailed attribute, the prediction information, etc., and can perform travel control in which the state ahead of the own vehicle is predicted. In addition, information such as a warning can be provided to the driver in advance. When the own vehicle is near the dynamic object, the automated driving ECU 126 cannot acquire the detailed attribute, the prediction information, etc., but can perform travel control using the position and the simple attribute.

The flowchart shown in FIG. 6 can be executed with various modifications. In FIG. 6, when the determination result in step 310 is “NO”, the control proceeds to step 320. However, the present disclosure is not limited thereto. For example, when the additional analysis process does not include the prediction process such as movement prediction, the received dynamic information (i.e., position and simple attribute) may be discarded. This inhibits the empty space of the memory 142 from being decreased due to unused data remaining in the memory 142. In addition, the received dynamic information (i.e., position and simple attribute) may be transferred to the automated driving ECU 126 together with information indicating that the transfer delay Tt is equal to or greater than the allowable delay Tp. This allows the automated driving ECU 126 to determine whether or not use of the dynamic information is appropriate, and the dynamic information can be used.

Furthermore, whether or not the allowable delay Tp is greater than the transfer delay Tt is determined in step 310, but the present disclosure is not limited thereto. Even when Tp>Tt is satisfied, there is no time for executing an additional analysis process if the difference between Tp and Tt is small. Therefore, it is preferable to determine whether or not the difference between Tp and Tt is equal to or more than a predetermined value not less than 0. The predetermined value may be, for example, the minimum value among the processing times of a plurality of additional analysis processes to be performed. Thus, an appropriate additional analysis process can be selected, thereby inhibiting steps 312 and 314 from being unnecessarily executed.

The case of analyzing the sensor data stored in the memory 142 is described as the additional analysis process for the sensor data. However, the present disclosure is not limited thereto. There is a case where no sensor data is added to the dynamic information (i.e., position and simple attribute) received by the in-vehicle system 100. In such a case, regarding the dynamic object included in the dynamic information, sensor data cannot be analyzed and detailed attribute cannot be detected. Therefore, it is preferable for the in-vehicle gateway 122 to newly acquire sensor data, and analyze the sensor data to detect a detailed attribute. Such a process will be described with reference to FIG. 7.

In the case of newly acquiring sensor data, a time for requesting the infrastructure sensor 104, the in-vehicle system 110, etc., to transmit the sensor data and receiving the sensor data, is needed, and this time will be a delay time. Therefore, it is preferable to select an executable additional analysis process while considering the data reception time. For example, regarding the additional analysis process to be performed on the sensor data, the data reception time is also stored in the processing time table 212. For example, regarding the additional analysis process to be performed on the sensor data, whether or not this process is executable can be determined by determining whether or not the sum of the processing time and the data reception time is equal to or less than the difference between the allowable delay and the transfer delay. Thus, even in the case of newly receiving sensor data, an appropriate additional analysis process can be selected.

The process shown in FIG. 7 is a specific example of step 316 shown in FIG. 6. In step 400, the controller 140 designates one of the additional analysis processes specified in step 314. Thereafter, the control proceeds to step 402.

In step 402, the controller 140 determines whether or not the additional analysis process designated in step 400 is a process to be performed on the sensor data (i.e., sensor data process). When the process is the sensor data process, the control proceeds to step 404. Otherwise (i.e., non-sensor data process), the control proceeds to step 408.

In step 404, the controller 140 determines whether or not the sensor data including the dynamic object included in the dynamic information is stored in the memory 142. As described above, the infrastructure sensor 104, the in-vehicle system 110, etc., may sometimes transmit the dynamic information and the corresponding sensor data. When the in-vehicle system 110 has received such data, the sensor data is stored in the memory 142. When it is determined that the sensor data is stored, the control proceeds to step 408. Otherwise, the control proceeds to step 406.

In step 406, the controller 140 transmits, to the external device, a request for transmission of the sensor data including the dynamic object, and receives the sensor data transmitted in response to the request. For example, the controller 140 requests the infrastructure sensor, which is located near the position of the dynamic object (e.g., stored in the memory 142 as the dynamic information), to transmit the sensor data. In this case, if the infrastructure sensor has, stored therein, the sensor data within a predetermined time period in the past, the controller 140 may make the transmission request while designating the time when the sensor data was stored. For example, the controller 140 requests the sensor data in a time period including the acquisition time of the dynamic information stored in the memory 142. This increases the possibility that the sensor data including the target dynamic object can be acquired. The controller 140 may request an in-vehicle system of a vehicle traveling near the position of the dynamic object to transmit the sensor data.

In step 408, the controller 140 executes the additional analysis process designated in step 400. In this case, when the additional analysis process is a process of analyzing the sensor data and the sensor data has been acquired in step 406, the sensor data is analyzed. When the sensor data cannot be received within the predetermined time period in step 406, the additional analysis process is not executed.

In step 410, the controller 140 determines whether or not any additional analysis process to be executed still remains. When it is determined that such an additional analysis process still remains, the control returns to step 400. Otherwise, the control returns to the flowchart shown in FIG. 6 and proceeds to step 318. When the control has returned to step 400, an additional analysis process is newly designated in step 400 so as not to overlap with the already-executed additional analysis process, and the above-described processes are repeated.

As described above, regarding the additional analysis process to be performed on the sensor data, if the sensor data is not stored in the memory 142, the sensor data is received from the external device, and the received data is analyzed to detect the detailed attribute. Even in the case where the sensor data is newly acquired and analyzed, an appropriate specific analysis process can be selected, and the analysis result can be effectively used for travel control of the vehicle.

In the above description, in the flowchart shown in FIG. 6, after all the executable additional analysis processes are specified in step 314, the specified additional analysis processes are executed in step 316. However, the present disclosure is not limited thereto. Each time an executable additional analysis process is specified, the specified additional analysis process may be executed. For example, instead of steps 314 and 316, whether or not any one additional analysis process can be completed within Tp−Tt is determined, and the process is executed if the process can be completed. Then, whether or not another additional analysis process can be completed within a value (i.e., time) obtained by subtracting the processing time required for the executed additional analysis process from Tp−Tt, is determined, and this process is executed if the process can be completed. By repeating this process, a plurality of additional analysis processes can be executed.

In the above description, in step 318 in FIG. 6, the dynamic information is transferred to the automated driving ECU 126 together with the result of the additional analysis process. However the present disclosure is not limited thereto. The process of transferring the received dynamic information to the automated driving ECU 126 and the selected additional analysis process may be executed in parallel. Thus, new data (e.g., dynamic information) can be promptly transferred to the automated driving ECU 126, and the automated driving ECU 126 can promptly reflect the transferred data in the travel control of the own vehicle.

Meanwhile, the result of the additional analysis process performed on the sensor data may be subjected to the additional analysis process for the non-sensor data. That is, the additional analysis process for the non-sensor data can be executed with at least one of the dynamic information and the result of the additional analysis process performed on the sensor data being a processing target. For example, the detailed attribute is obtained as a result of the additional analysis process performed on the sensor data. The detailed attribute may be added to the dynamic information (i.e., position and simple attribute) to generate processing target data, and the processing target data may be subjected to an additional analysis process for obtaining movement prediction or traffic state prediction. This improves the accuracy of the additional analysis process for the non-sensor data.

### [Change in Driving Support Information]

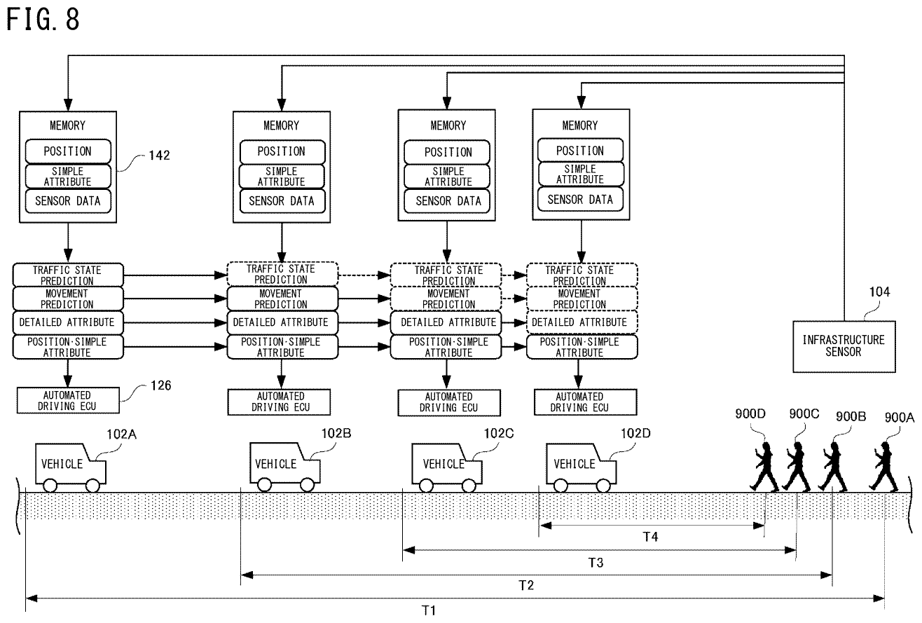

With reference to FIG. 8, how the driving support information generated by the in-vehicle system 100 of one vehicle 102 changes as the vehicle 102 approaches a dynamic object, will be described. In FIG. 8, vehicles 102A to 102D represent the same vehicle 102 whose position changes over time. Likewise, pedestrians 900A to 900D represent the same pedestrian 900 whose position changes over time. The pedestrians 900A to 900D are using a smartphone while walking, for example. A vehicle and a person having the same alphabet at the tails of the signs are those at the same time. As described above, the driving support information is generated considering the allowable delay Tp that is an estimated time until the vehicle reaches the dynamic object. Therefore, FIG. 8 shows allowable delays T1 to T4 calculated according to the distance between the traveling vehicle and the dynamic object. As the vehicle 102 approaches the pedestrian 900, the allowable delay decreases in order from T1 to T4. In FIG. 8, the position and the simple attribute are collectively indicated as “position • simple attribute”.

Here, it is assumed that the selectable additional analysis processes are the analysis processes for obtaining the detailed attribute, the movement prediction, and the traffic state prediction, respectively, and the processing times thereof are increased in order of the detailed attribute, the movement prediction, and the traffic state prediction. It is assumed that the vehicle-to-pedestrian distance is relatively large and the vehicle 102A is traveling on the road where the allowable delay Tp satisfies T1≥Tp>T2. The in-vehicle gateway 122 of the vehicle 102A executes the additional analysis processes and generates the detailed attribute, the movement prediction, and the traffic state prediction. By using the analysis results thereof and the position and simple attribute received from the external device such as the infrastructure sensor 104, hierarchized driving support information is generated. The generated driving support information is transferred to the automated driving ECU 126 and is stored in the memory 142.

When the vehicle-to-pedestrian distance decreases and the vehicle 102B is traveling on the road where the allowable delay Tp is T2≥Tp>T3, the in-vehicle gateway 122 executes the additional analysis process of generating the detailed attribute and the movement prediction. The in-vehicle gateway 122 of the vehicle 102B does not perform the additional analysis process for generating the traffic state prediction. The hierarchized driving support information is generated by using the analysis result (i.e., the detailed attribute and the movement prediction), and the position and simple attribute. The generated driving support information is transferred to the automated driving ECU 126. In FIG. 8, each of right-pointing solid arrows indicates that the corresponding information is generated and updated during the period, and each of right-pointing broken arrows indicates that the corresponding information is not generated and updated during the period. Information indicated by a broken line represents non-updated information.

When the vehicle-to-pedestrian distance further decreases and the vehicle 102C travels on the road where the allowable delay Tp is T2≥Tp>T1, the in-vehicle gateway 122 executes the additional analysis process of generating the detailed attribute. The in-vehicle gateway 122 of the vehicle 102C does not execute the additional analysis process for generating the movement prediction and the traffic state prediction. The hierarchized driving support information is generated by using the analysis result (i.e., the detailed attribute), and the position and simple attribute. The generated driving support information is transferred to the automated driving ECU 126.

When the vehicle-to-pedestrian distance further decreases and the vehicle 102D travels on the road where the allowable delay Tp is T1≥Tp>0, the in-vehicle gateway 122 executes none of the additional analysis processes. The in-vehicle gateway 122 transfers the position and simple attribute received from the outside, as the driving support information to the automated driving ECU 126.

As described above, in one vehicle, the driving support information used for travel control of the vehicle changes. The driving support information that changes according to the traveling state of the vehicle is provided to the automated driving ECU 126, whereby traveling of the vehicle is appropriately controlled.

### [Presentation to Driver]

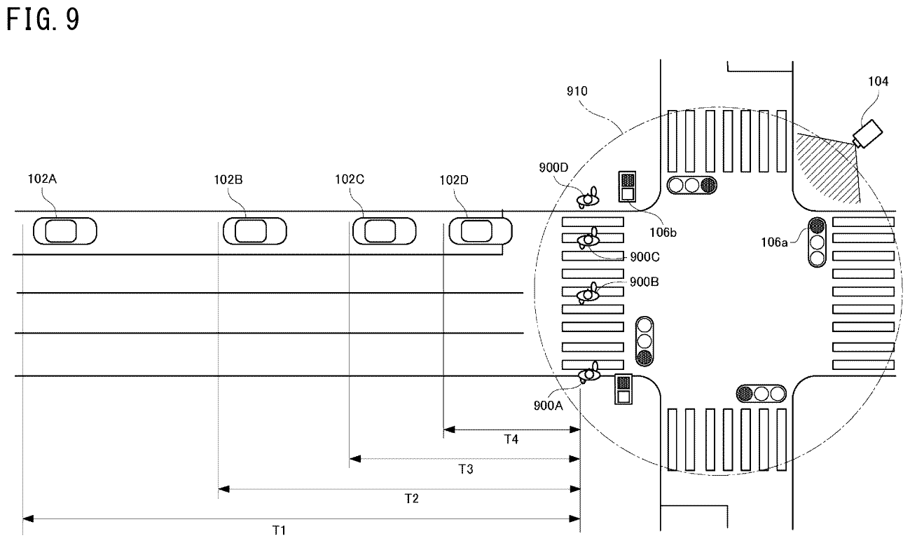

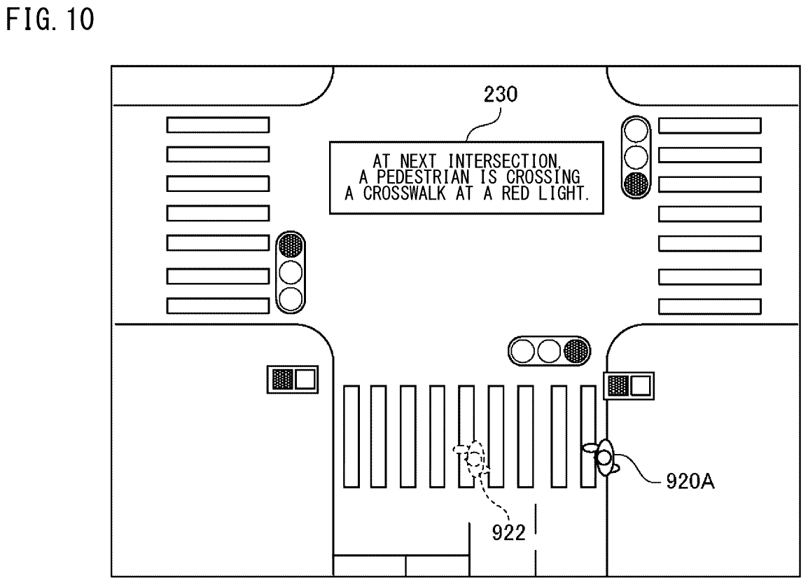

The in-vehicle system 100 can appropriately present information to the driver by using the driving support information. An example of change in the information that the in-vehicle system 100 presents will be described with reference to FIG. 9 to FIG. 13. FIG. 9 shows the vehicles 102A to 102D and the pedestrians 900A to 900D shown in FIG. 8 two-dimensionally, i.e., on a road map. In an intersection 910, traffic signals and the infrastructure sensor 104 are installed. FIG. 9 shows a state in which a vehicle traffic signal 106a indicates green light and a pedestrian traffic signal 106b indicates red light. Although the pedestrian traffic signal 106b indicates red light, the pedestrian 900 (i.e., pedestrians 900A to 900D) crosses the crosswalk while using a smartphone (i.e., ignores the traffic signal). In such a situation, for example, the in-vehicle system 100 of the vehicle 102 provides the driver with information as shown in FIG. 10 to FIG. 13 with the lapse of time.

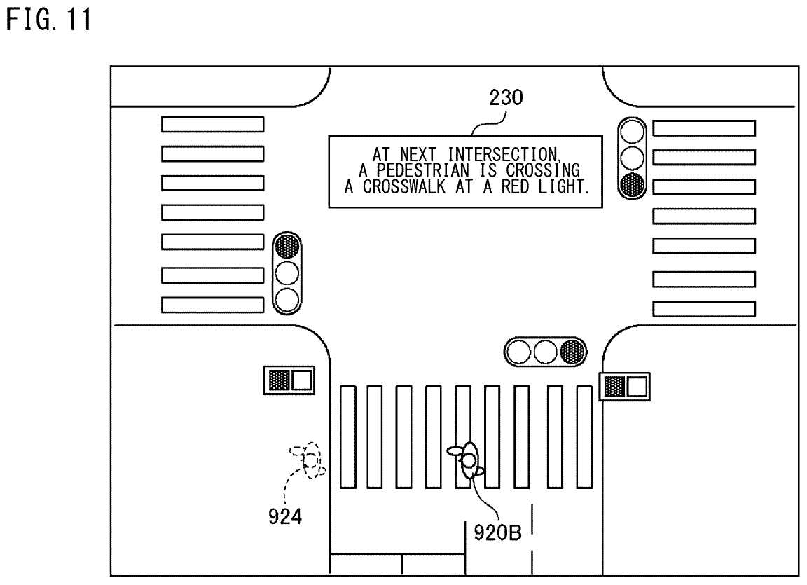

As described above, the driving support information generated by the in-vehicle gateway 122 of the vehicle 102A traveling at the position where the distance to the dynamic object (i.e., pedestrian 900A) is large (i.e., allowable delay Tp is T1≥Tp>T2) includes the detailed attribute, the movement prediction, and the traffic state prediction which are the analysis results, and the received dynamic information (i.e., position and simple attribute). Based on the dynamic information (i.e., position and simple attribute), the in-vehicle system 100 displays a FIG. 920A representing the current pedestrian (i.e., pedestrian 900A) on a map near the intersection 910 as shown in FIG. 10, on a part of a display screen of a car navigation system, for example. Since the FIG. 920A is on the crosswalk even though the traffic signal 106b indicates red light, the in-vehicle system 100 can specify that a dangerous situation is occurring (there is a pedestrian who starts to cross the crosswalk while ignoring the traffic signal in the intersection 910 located in the traveling direction of the own vehicle). Therefore, the in-vehicle system 100 displays a warning message 230. Furthermore, the in-vehicle system 100 displays a FIG. 922 representing the dynamic object after t1 seconds which is included in the movement prediction. In FIG. 10, the figure representing the current dynamic object is shown by a solid line, and the figure representing the future dynamic object specified based on the movement prediction is shown by a broken line (the same applies to FIG. 11 to FIG. 13).

Thus, the driver of the vehicle 102 can know that there is the pedestrian who has started to cross the crosswalk while ignoring the traffic signal, in the intersection 910 ahead of the vehicle 102. Furthermore, the driver can know that the pedestrian will highly possibly be on the crosswalk in the future (e.g., after t1 seconds), and decide to drive carefully.

Thereafter, when the distance to the dynamic object (i.e., pedestrian 900B) decreases (i.e., allowable delay Tp is T2≥Tp>T3), the driving support information generated by the in-vehicle gateway 122 of the vehicle 102B includes the detailed attribute and the movement prediction which are the analysis results and the received dynamic information (i.e., position and simple attribute). Based on the dynamic information (i.e., position and simple attribute), the in-vehicle system 100 displays a FIG. 920B representing the current pedestrian (i.e., pedestrian 900B) on the map, as shown in FIG. 11. Since the FIG. 920B is on the crosswalk, the in-vehicle system 100 can specify that the dangerous situation continues, and maintains the displayed message 230. Furthermore, using the movement prediction, the in-vehicle system 100 displays a FIG. 924 representing the future pedestrian (e.g., the dynamic object after t2 seconds).

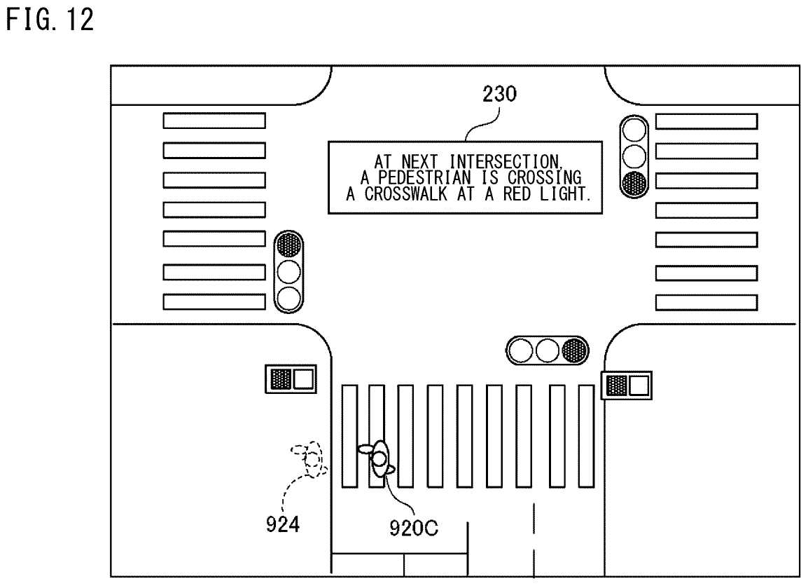

Thereafter, when the distance to the dynamic object (i.e., pedestrian 900C) further decreases (i.e., allowable delay Tp is T3≥Tp>T4), the driving support information generated by the in-vehicle gateway 122 of the vehicle 102C includes the detailed attribute as the analysis result and the received dynamic information (i.e., position and simple attribute). Based on the dynamic information (i.e., position and simple attribute), the in-vehicle system 100 displays a FIG. 920C representing the current pedestrian (i.e., pedestrian 900C) on the map, as shown in FIG. 12. Since the FIG. 920C is on the crosswalk, the in-vehicle system 100 can specify that the dangerous situation still continues, and maintains the displayed message 230. Since no movement prediction is generated, the same FIG. 924 as that in FIG. 11 is displayed on FIG. 12.

The representation as shown in FIG. 11 and FIG. 12 allows the driver of the vehicle to know that the pedestrian is still crossing the crosswalk while ignoring the traffic signal in the intersection 910 ahead of the vehicle, and that he/she needs to drive carefully.

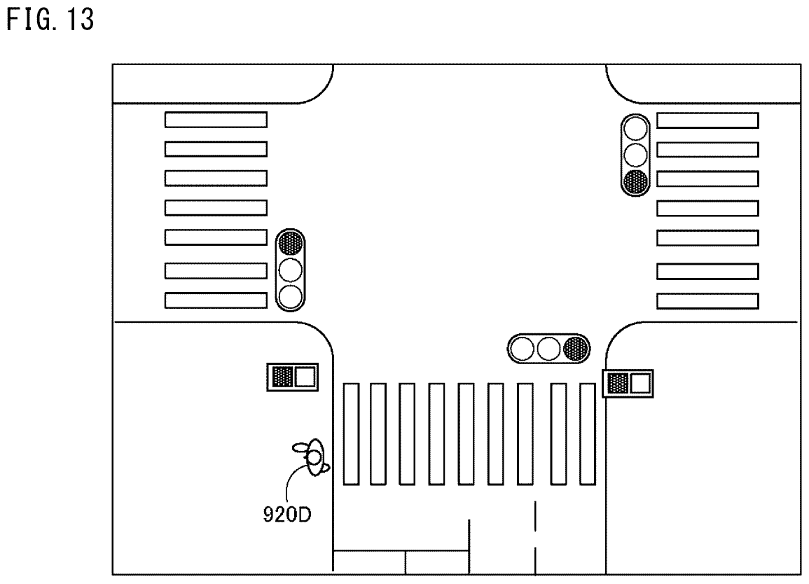

Thereafter, when the distance to the dynamic object (i.e., pedestrian 900D) further decreases (i.e., allowable delay Tp is T4≥Tp>0), the in-vehicle gateway 122 of the vehicle 102D executes no additional analysis process. Therefore, the real-time information included in the driving support information is only the received dynamic information (i.e., position and simple attribute). Based on the dynamic information (i.e., position and simple attribute), the in-vehicle system 100 displays a FIG. 920D representing the current pedestrian (i.e., pedestrian 900D) on the map, as shown in FIG. 13. Since the FIG. 920D is on the sidewalk, the in-vehicle system 100 can specify that the dangerous situation has been eliminated, and deletes the displayed message 230. Thus, the driver of the vehicle knows that the danger has passed, i.e., the pedestrian has just crossed the crosswalk, in the intersection 910 ahead.

As described above, the in-vehicle gateway 122 generates the hierarchized driving support information according to the estimated time (i.e., allowable delay) until the vehicle 102 reaches the dynamic object. As a result, the in-vehicle system 100 can present, to the driver of the vehicle, that a dangerous situation has occurred, thereby making a warning. The kinds (i.e., hierarchy) of information to be included in the driving support information vary according to the allowable delay. Therefore, the in-vehicle system 100 can appropriately perform driving support without generating unnecessary information for the own vehicle.

In the above description, the dynamic object is a pedestrian. However, the present disclosure is not limited thereto. Any moving object that will be damaged when being hit by a vehicle may be an object to be detected. A person riding a bicycle, an animal, etc., may be objects to be detected.

### [Modifications]

In the above description, as shown in FIG. 3, the in-vehicle gateway 122 as standard equipment for the in-vehicle system 100 generates the driving support information. However, the present disclosure is not limited thereto. In a modification, driving support information is generated by a device that is not standard equipment for an in-vehicle system but can be installed in the system later.

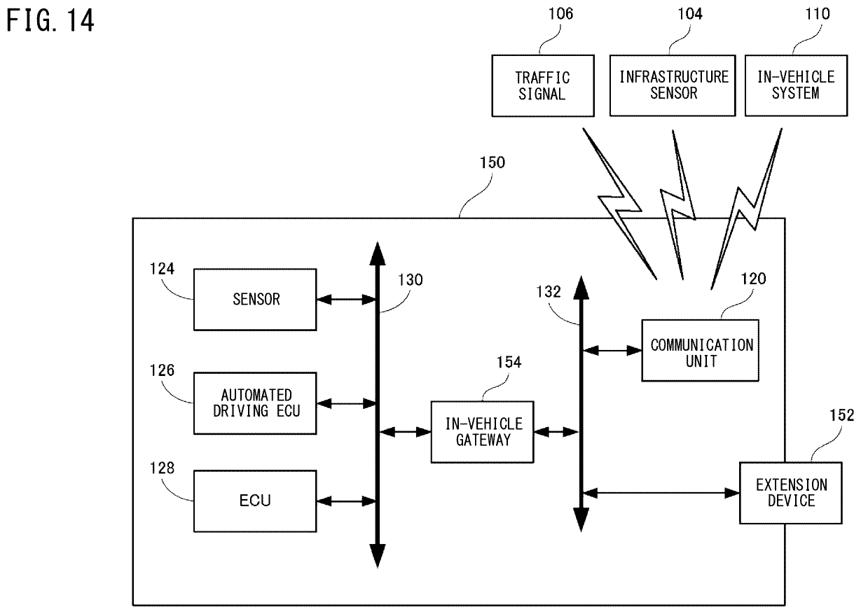

With reference to FIG. 14, an in-vehicle system 150 installed in a vehicle includes a communication unit 120, an in-vehicle gateway 154, a sensor 124, an automated driving ECU 126, an ECU 128, a bus 130, and a bus 132. The in-vehicle system 150 includes an extension device 152 that is not standard equipment but is installed later. In FIG. 14, the components assigned the same reference signs as in FIG. 3 have the same functions as in FIG. 3. Hereinafter, the components different from those shown in FIG. 3 will be mainly described.

The in-vehicle system 150 includes the bus 132 similar to the bus 130. The communication unit 120 exchanges data with the in-vehicle gateway 154 via the bus 132. That is, the communication unit 120 transfers data received from the outside to the in-vehicle gateway 154 via the bus 132, and transmits, to the outside, data transferred from the in-vehicle gateway 154 via the bus 132.

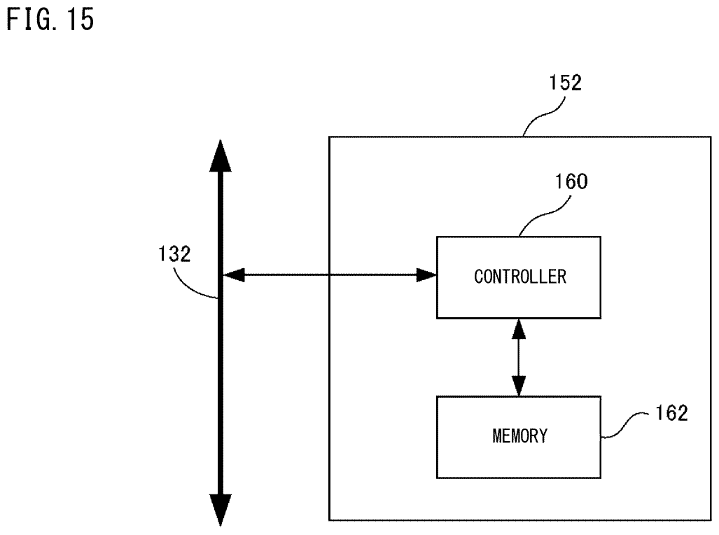

With reference to FIG. 15, the extension device 152 includes a controller 160 and a memory 162. The controller 160 is configured to include a CPU, and controls the memory 162. The memory 162 is, for example, a rewritable nonvolatile semiconductor memory, and has, stored therein, a program that the controller 160 executes. The memory 162 provides a work area for the program that the controller 160 executes. The controller 160 acquires data to be processed via the bus 132, stores the processing result in the memory 162, and outputs the processing result to the bus 132 as appropriate. The extension device 152 has the same function as the in-vehicle gateway 122 shown in FIG. 3, that is, the function shown in FIG. 4.

The extension device 152 can acquire, via the bus 132, data received by the communication unit 120 (e.g., signal information, vehicle information (e.g., position, speed, traveling direction), dynamic information, sensor data, etc.). In contrast to the in-vehicle gateway 122, the in-vehicle gateway 154 does not have the function shown in FIG. 4. The in-vehicle gateway 154 transfers, to the extension device 152 via the bus 132, sensor data outputted from the sensor 124 to the bus 130. The in-vehicle gateway 154 acquires the speed of the own vehicle from a driving unit that causes the own vehicle to travel, and transfers the same to the extension device 152 via the bus 132. In addition, the in-vehicle gateway 154 transfers, to the automated driving ECU 126 via the bus 130, data outputted from the extension device 152 to the bus 132. Thus, the extension device 152 can execute an additional analysis process according to a time (i.e., allowable delay) until the own vehicle reaches the dynamic object, and generate hierarchized driving support information. The driving support information is transferred to the automated driving ECU 126 to be used for travel control for the own vehicle.

The driving support information generated in the vehicle 102 may be transmitted to an in-vehicle system of another vehicle, such as the in-vehicle system 110 of the vehicle 112. For example, the in-vehicle gateway 122 generates packet data including driving support information, and transmits the packet data from the communication unit 120 to the in-vehicle system 110 of the vehicle 112 via the base station 108. Transmission of the driving support information from the communication unit 120 is performed by broadcasting, for example. Thus, the driving support information can be used for automated driving of the other vehicle. For example, if the vehicle 112 travels near the vehicle 102 at almost the same speed as the vehicle 102, these vehicles 112, 102 are considered to require almost the same time to reach the same dynamic object. Therefore, there is a possibility that the in-vehicle system 110 can use the received driving support information for automated driving of the vehicle 112.

When the in-vehicle gateway 122 of the vehicle 102 determines which additional analysis process should be executed in order to generate driving support information that can be used for the other vehicle, it is preferable to consider a communication time between the vehicles (i.e., data transmission time to the other vehicle) as a delay time, in addition to the allowable delay, the transfer delay, the processing time, etc. Thus, the possibility that the driving support information generated in the vehicle 102 is effectively used for travel control of the other vehicle is increased.

The processes (functions) of the above-described embodiment may be realized by a processing circuit (circuitry) including one or more processors. In addition to the one or more processors, the processing circuit may include an integrated circuit or the like in which some of one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU, a GPU (Graphics Processing Unit), a DSP (Digital Signal Processor), an FPGA (Field Programmable Gate Array), an ASIC (Application Specific Integrated Circuit), etc., which are compatible with computer control.

Moreover, a recording medium having, stored therein, a program that causes a computer to execute the processes of the in-vehicle device 100 (specifically, the processes that the in-vehicle gateway 122 executes (e.g., the processes shown in FIG. 6 and FIG. 7)) can be provided. The recording medium is, for example, an optical disc (DVD (Digital Versatile Disc), etc.) or a detachable semiconductor memory (USB (Universal Serial Bus) memory, etc.). The computer program may be transmitted through a communication line, with the recording medium being a non-transitory recording medium. By causing the computer installed in the vehicle to read the program stored in the recording medium, the computer is enabled to generate driving support information that is appropriately hierarchized in the own vehicle according to an estimated time until the own vehicle reaches the dynamic object, and the driving support information can be used for travel control for the own vehicle, as described above.

### (Additional Note)

That is, a computer-readable non-transitory recording medium causes a computer installed in a vehicle to realize:
an allowable delay estimation function of estimating, as an allowable delay, a time until the vehicle reaches a dynamic object;
a transfer delay estimation function of estimating, as a transfer delay, a time from when the computer receives data from outside of the vehicle to when the computer transfers the data to an execution unit for executing an automated driving function, based on load states of information processing and information transfer in the vehicle;
a determination function of selecting a specific analysis process from among a plurality of analysis processes for analyzing the data received from the outside, based on a difference between the allowable delay and the transfer delay; and
a driving support information generation function of generating driving support information by executing the specific analysis process selected by the determination function, wherein
the data received from the outside includes information regarding the dynamic object, and
the driving support information is transferred to the execution unit for executing the automated driving function.

While the present invention has been described through description of embodiment above, the above embodiment is merely illustrative and the present invention is not limited to only the above embodiment. The scope of the present invention is defined by each claim of the scope of the claims with reference to the above description, and includes meanings equivalent to the wordings described therein and all modifications within the scope of the claims.

### REFERENCE SIGNS LIST

100, 110, 150 in-vehicle system
102, 112, 102A, 102B, 102C, 102D vehicle
104 infrastructure sensor
106, 106a, 106b traffic signal
108 base station
114 network
120 communication unit
122, 154 in-vehicle gateway
124 sensor
126 automated driving ECU
128 ECU
130, 132 bus
140, 160 controller
142, 162 memory
152 extension device
200 storage unit
202 allowable delay estimation unit
204 determination unit
206 transfer delay estimation unit
208 additional analysis processing unit
210 output unit
212 processing time table
230 message
300, 302, 304, 306, 308, 310, 312, 314, 316, 318, 320, 400, 402, 404, 406, 408,
410 step
900, 900A, 900B, 900C, 900D pedestrian
910 intersection
920A, 920B, 920C, 920D, 922, 924 figure
   T1, T2, T3, T4, Tp allowable delay

1. An in-vehicle device installed in a vehicle having an automated driving function, comprising:
an allowable delay estimation unit configured to estimate, as an allowable delay, a time until the vehicle reaches a dynamic object;
a transfer delay estimation unit configured to estimate, as a transfer delay, a time from when the in-vehicle device receives data from outside of the vehicle to when the in-vehicle device transfers the data to an execution unit for executing the automated driving function, based on load states of information processing and information transfer in the vehicle;
a determination unit configured to select a specific analysis process from among a plurality of analysis processes for analyzing the data received from the outside, based on a difference between the allowable delay and the transfer delay; and
a driving support information generation unit configured to generate driving support information by executing the specific analysis process selected by the determination unit, wherein
the data received from the outside includes information regarding the dynamic object, and
the driving support information is transferred to the execution unit for executing the automated driving function.

2. The in-vehicle device according to claim 1, wherein
the data received from the outside further includes sensor data,
the information regarding the dynamic object includes position information and simple attribute information of the dynamic object, and
the driving support information generation unit generates the driving support information that is hierarchized so as to include, as hierarchical layers, a result of the specific analysis process, and the position information and the simple attribute information.

3. The in-vehicle device according to claim 2, wherein
the driving support information includes:
a first layer including an analysis result of the specific analysis process performed on the sensor data being a processing target; and
a second layer including an analysis result of the specific analysis process not performed on the sensor data.

4. The in-vehicle device according to claim 2, wherein
the specific analysis process not performed on the sensor data has, as a processing target, at least one of the analysis result of the specific analysis process performed on the sensor data, and the information regarding the dynamic object.

5. The in-vehicle device according to claim 1, wherein
the determination unit
calculates the difference by subtracting the transfer delay from the allowable delay,
determines whether or not the difference is larger than a predetermined value that is equal to or larger than 0,
selects the specific analysis process when the difference is larger than the predetermined value, and
does not select the specific analysis process when the difference is equal to or smaller than the predetermined value.

6. The in-vehicle device according to claim 5, wherein
when the difference is equal to or smaller than the predetermined value, the information regarding the dynamic object is transferred to the execution unit together with information indicating that the transfer delay is equal to or larger than the allowable delay.

7. The in-vehicle device according to claim 5,
further comprising a storage unit having, stored therein, a processing time table in which, for each of the plurality of analysis processes, a processing time corresponding to an amount of data to be processed is recorded, wherein
when the difference is larger than the predetermined value, the determination unit specifies a processing time for the data with reference to the processing time table by using the amount of the data, and thereafter determines whether or not the processing time is equal to or less than the difference, thereby selecting the specific analysis process.

8. The in-vehicle device according to claim 7, wherein
the processing time table further includes an acquisition time required for newly acquiring sensor data being a processing target, regarding an analysis process having the sensor data as the processing target among the plurality of analysis processes, and
when the difference is larger than the predetermined value, the determination unit determines whether or not a sum of the processing time and the acquisition time, which are specified with reference to the processing time table, is equal to or smaller than the difference, thereby selecting the specific analysis process.

9. An in-vehicle system installed in a vehicle having an automated driving function, comprising:
an execution unit configured to execute the automated driving function;
a communication unit configured to acquire data including information regarding a dynamic object; and
the in-vehicle device according to claim 1.

10. The in-vehicle system according to claim 9, wherein
the communication unit transmits the driving support information generated by the in-vehicle device to another vehicle together with information on a position and a traveling direction of the vehicle.

11. The in-vehicle system according to claim 10, wherein
the determination unit of the in-vehicle device
estimates a communication time of the driving support information to be transmitted from the communication unit, and
selects the specific analysis process from among the plurality of analysis processes, based on a difference between the allowable delay and a sum of the transfer delay and the communication time.

12. A control method for supporting an automated driving function of a vehicle, the method comprising:
an allowable delay estimation step of estimating, as an allowable delay, a time until the vehicle reaches a dynamic object;
a transfer delay estimation step of estimating, as a transfer delay, a time from when an in-vehicle device installed in the vehicle receives data from outside of the vehicle to when the in-vehicle device transfers the data to an execution unit for executing the automated driving function, based on load states of information processing and information transfer in the vehicle;
a determination step of selecting a specific analysis process from among a plurality of analysis processes for analyzing the data received from the outside, based on a difference between the allowable delay and the transfer delay; and
a driving support information generation step of generating driving support information by executing the specific analysis process selected in the determination step, wherein
the data received from the outside includes information regarding the dynamic object, and
the driving support information is transferred to the execution unit for executing the automated driving function.

13. A non-transitory computer readable storage medium storing a computer program that causes a computer installed in a vehicle to execute:
an allowable delay estimation function of estimating, as an allowable delay, a time until the vehicle reaches a dynamic object;
a transfer delay estimation function of estimating, as a transfer delay, a time from when the computer receives data from outside of the vehicle to when the computer transfers the data to an execution unit for executing the automated driving function, based on load states of information processing and information transfer in the vehicle;
a determination function of selecting a specific analysis process from among a plurality of analysis processes for analyzing the data received from the outside, based on a difference between the allowable delay and the transfer delay; and
a driving support information generation function of generating driving support information by executing the specific analysis process selected by the determination function, wherein
the data received from the outside includes information regarding the dynamic object, and
the driving support information is transferred to the execution unit for executing the automated driving function.
